(19) United States
(12) Patent Application Publication
(10) Pub. No.: US 2009/0211134 A1
(43) Pub. Date: Aug. 27, 2009

(54) FRAME PRODUCED AS ONE-PIECE BODY

(75) Inventor: Ali Topcuoglu, Istanbul (TR)

Correspondence Address: MATTHIAS SCHOLL, 14781 MEMORIAL DRIVE, SUITE 1319, HOUSTON, TX, 77079, US

(73) Assignee: M. T REKLAM VE PAZARLAMA SANAYI TICARET LIMITED SI, Istanbul (TR)

(21) Appl. No.: 12/301,031

(22) PCT Filed: May 4, 2006
(86) PCT No.: PCT/TR2006/000018

§ 371 Date: Nov. 17, 2008

(51) Int. Cl. G09F 15/00; B23P 13/00

(52) U.S. Cl. 40/606.17; 40/606.01; 29/896.9

(57) ABSTRACT

A frame for displaying an advertisement poster comprising: a body (1) formed as a single piece; at least one upper aluminum profile (2); and at least one spring (3); wherein the spring (3) is connected to the upper aluminum profile (2); and the spring (3) is mounted to the body (1). A method for manufacturing the frame comprising: (a) manufacturing at least one the spring (3); (b) manufacturing at least one the upper aluminum profile (2) by aluminum extrusion; (c) manufacturing the body (1) by plastic injection molding; and (d) mounting the upper aluminum profile (2) and the spring (3) to the body (1).

### CROSS-REFERENCE TO RELATED APPLICATIONS

This is a National Stage Application of International Patent Application No. PCT/TR2006/000018, with an international filing date of May 4, 2006, the contents of which are incorporated herein by reference.

### BACKGROUND OF THE INVENTION

1. Field of the Invention

The present invention relates to the field of advertisement displays, and particularly to a frame for displaying advertisement posters that provides savings in manufacturing and labor costs, owing to its being manufactured in one stage as a single part by means of injection molding, and to the method for manufacturing the same.

2. Description of the Related Art

Aluminum frames are used for the exhibition of advertisement posters in interior spaces. Aluminum frames generally comprise lower aluminum profiles, upper aluminum profiles, background (polystyrene), springs, corner connection elements and PVC protection elements.

Aluminum frames are manufactured in 5 preparatory stages and 5 assembly stages. Preparatory stages comprise the following:
cutting the springs in the form of strips with the special machines to sizes suitable for the frame,
manufacturing the lower and upper aluminum profiles by aluminum extrusion method, cutting these profiles in necessary sizes, joining the lower and upper profiles by means of springs and cutting the profiles at 45° angles,
providing the background (polystyrene) and cutting the same into necessary sizes,
cutting and boring metal pieces provided with suitable hardness for the corner connections in press and molding machines, threading holes, coating the same, and screwing together once the corner connections have been made, and
manufacturing PVC protection elements, cutting the same to required dimensions, and opening a canal on one side of PVC to facilitate the opening of the frame from the interior.

Assembly stages comprise the following:
after the lower and upper aluminum profiles have been drilled, the corner connection elements are attached to two reciprocal edges and the screws and the screw blank spaces are removed;
joining one of the edges, to which the corner connection elements have been attached, to the other two edges by means of the corner connection elements (edges take the shape of U);
applying the background (polystyrene) through the canals located on the lower profile on the edges that have taken a U-shape;
once the background (polystyrene) has been fixed, mounting it on the other U shaped edges by means of corner connection elements; and
placing the PVC protection element at the position delimited by the lower profile, whereby the frame is made ready for the end user.

Because the number of parts in the frame body comprised of the lower aluminum profiles, corner connection elements enabling the assembly of the edges, the background, and the polystyrene layer forming the background is relatively high, the assembly and labor costs are high. In addition, aluminum profiles are produced using the extrusion method, which is similarly time consuming.

Moreover, various hanger elements are attached to the background, in order to enable the frames to be suspended from a location. This leads to extra costs, and makes the production stages even more difficult. Due to the attachment of the hanger elements to the frame, the frame has a certain clearance from the wall, which often constitutes a problem.

Accordingly, there is the need for a new frame, which enables the production in a single step without the use of the lower aluminum profiles, corner connection elements and the background to comprise the frame body, and hence provides savings of the manufacturing costs.

### BRIEF SUMMARY OF THE INVENTION

It is an object of the invention to provide a new frame, which enables the aluminum frames where the advertisement posters are displayed to be manufactured in a shorter time and at a lower cost, and the production method for the frame.

It is another object of the invention to provide savings in the operating costs by forming a new frame comprising a body made by the plastic injection method and the springs connected to the aluminum profiles placed on the body, without using the lower aluminum profiles, corner connection elements and the background.

It is another object of the invention to provide savings in the manufacturing and labor costs by providing a body formed at a single stage without using the lower aluminum profiles, corner connection elements and the background.

It is yet another object of the invention to provide the ease of use by means of a portable thrust unit formed on the back of the frame.

It is still another object of the invention to provide a shorter manufacturing time for the plastic-based body produced at single stage by injection molding, and the frames formed by placing the spring, aluminum profile and the PVC protection on the body.

It is still another object of the invention to shorten the duration of the preparatory and assembly stages for the frames.

In order to attain the aforesaid objects, a new frame has been developed, which consists of a body formed by the plastic injection method, and the springs in connection with the aluminum profiles located on the body. The body produced at a single stage is used, without the need to use the lower aluminum profiles, corner connection elements and the background. This provides shortened manufacturing stages. It enables a new frame to be produced at a shorter time with lower manufacturing costs.

According to a preferred embodiment of the invention, the method comprises the process steps of providing the springs in the form of strips and cutting the same in suitable sizes, cutting the upper aluminum profiles at certain sizes in an angled manner and subjecting the same to the boring process, forming the body by means of the plastic injection method, once the upper aluminum profiles have been subjected to boring process, mounting the same onto the body along with the springs and locating the PVC protection on the body.

According to a preferred embodiment of the invention, canals are formed on one side of the PVC protection and the upper aluminum profiles are cut at angles of 45°.

According to a preferred embodiment of the invention, at least one portable thrust unit is formed, to be optionally mounted on the body.

According to a preferred embodiment of the invention, at least one thrust unit assembly site is formed on the body, in order to enable the thrust unit to be mounted on the body.

According to a preferred embodiment of the invention, a body prepared in a single part, at least one upper aluminum profile located at the body and at least one spring have been formed.

According to a preferred embodiment of the invention, the body is obtained by means of the plastic injection molding.

According to a preferred embodiment of the invention, there is provided at least one upper aluminum profile housing formed on the body, at least one spring housing, at least one upper profile stopper and at least one hanger canal.

According to a preferred embodiment of the invention, there is provided at least one corner connection support located on the corner connection support housings formed at the comers of the body.

According to a preferred embodiment of the invention, there is provided at least one thrust unit formed to be mounted onto the body.

According to a preferred embodiment of the invention, there is provided at least one thrust unit assembly site and at least one thrust unit bearing, in order to enable the thrust unit to be mounted on the body when desired.

According to a preferred embodiment of the invention, there is provided at least one thrust fixer and thrust leg located on the thrust body comprising the thrust unit.

### BRIEF DESCRIPTION OF THE DRAWINGS

FIG. 1 is a perspective view showing the attachment of the corner connection elements according to the prior art;

FIG. 1a is a perspective view showing the attachment of the shorter edge formed by the upper and lower aluminum profiles to the other edges according to the prior art;

FIG. 1b is a perspective view showing the attachment of the background (polystyrene) to the frame according to the prior art;

FIG. 1c is a perspective view showing the attachment of the other edge according to the prior art.

FIG. 1d is a perspective view showing the assembly of the PVC protection according to the prior art;

FIG. 1e is a perspective view showing the frame used according to the prior art;

FIG. 2 is the front and cross-sectional views of the body according to a representative embodiment of the invention;

FIG. 3 is disassembled view of the frame with a complete body according to a representative embodiment of the invention;

FIG. 3a shows the disassembled and assembled perspective views of the frame with a complete body including the corner connection support according to an alternative representative embodiment of the invention;

FIG. 4 shows the front view and a detailed perspective view of the body according to a representative embodiment of the invention;

FIG. 5 shows the rear view and a detailed view of the body according to a representative embodiment of the invention;

FIG. 6 shows the views of the thrust unit in open and closed states, according to a representative embodiment of the invention;

FIG. 7 is a view showing the assembly of the upper aluminum profiles and the springs on the body, according to a representative embodiment of the invention;

FIG. 8 includes the view showing the assembly of the PVC protection and the perspective view of the frame that is ready for use, according to a representative embodiment of the invention;

FIG. 9 is a perspective view showing the assembly of the thrust unit on the body in a horizontal and vertical alignment, according to a representative embodiment of the invention;

FIG. 10 is a perspective view showing the assembly of the frame onto the wall, according to a representative embodiment of the invention;

FIG. 11 is a perspective view showing the hanging of the frame by means of the connection with the hanger canals, according to a representative embodiment of the invention;

FIG. 12 is a perspective view showing the use of the frame with the thrust unit according to a representative embodiment of the invention;

FIG. 13 is a representative view of the production by means of injection molding according to a representative embodiment of the invention; and

FIG. 14 is a representative view of the production of the aluminum profiles by means of the extrusion method according to the prior art.

### DETAILED DESCRIPTION OF THE INVENTION

This invention relates to aluminum frames enabling the advertisement posters to be displayed in various places, and it permits the aluminum frames to be produced in a shorter time and at a lower cost.

The body (1) formed by injection molding, the upper aluminum profiles (2) and the springs (3) to be mounted on the body (1), are provided. After the upper aluminum profiles (2) and the springs (3) connected to the same have been mounted on the body (1), the PVC protection (5) is mounted within the limits forming the frame. With the new frame formed in this way, the operating costs are reduced.

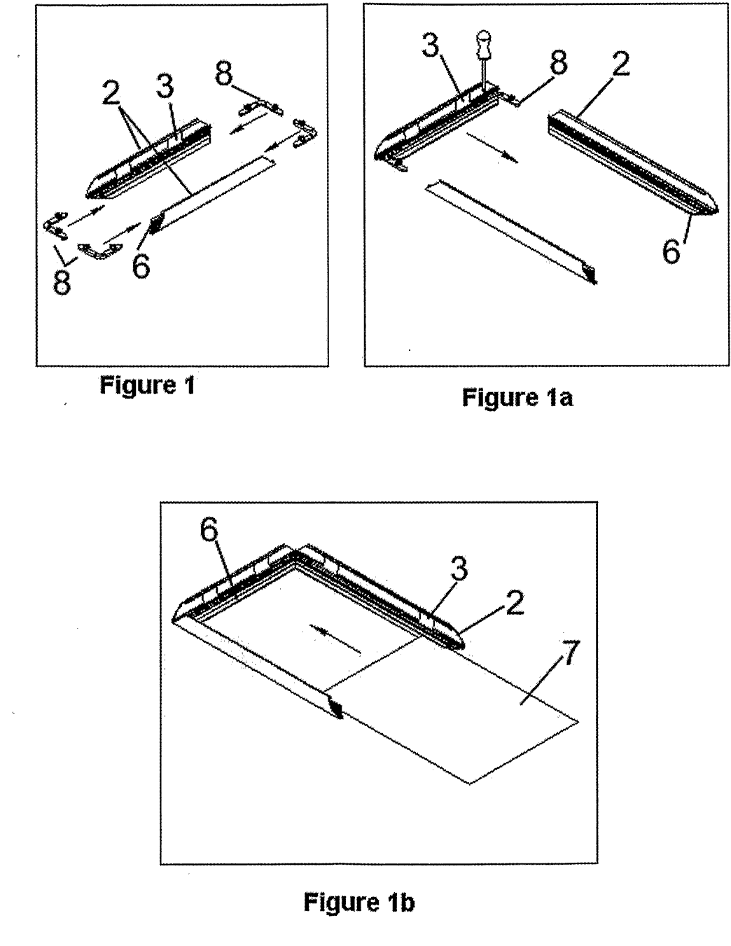

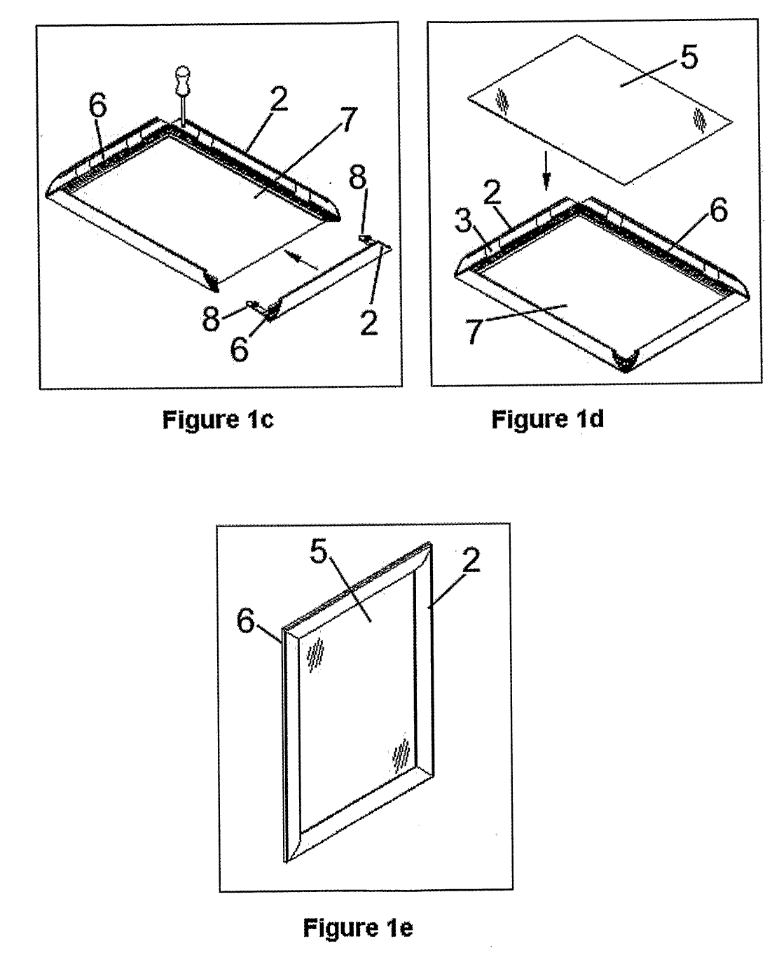

FIG. 1 is a perspective view showing the attachment of the corner connection elements (8) according to the prior art. In conventional frames, the corner connection elements (8) are mounted on the upper and lower aluminum profiles (2, 6) connected to the springs (3), forming the shorter edges.

FIG. 1a is a perspective view showing the attachment of the shorter edge formed by the upper and lower aluminum profiles (2, 6) to the other edges according to the prior art. One of the shorter edges is mounted to the upper and lower aluminum profiles (2, 6) connected to the springs (3), forming the longer edge.

FIG. 1b is a perspective view showing the attachment of the background (polystyrene) (7) to the frame according to the prior art. The background (7) is mounted from the open end of the frame, which is formed in a way to have one end open.

FIG. 1c is a perspective view showing the attachment of the other edge according to the prior art. After the background (7) has been attached, the other shorter edge is mounted.

FIG. 1d is a perspective view showing the assembly of the PVC protection (5) according to the prior, art. PVC protection (5) is mounted within the limits of the formed frame.

FIG. 1e is a perspective view of the frame used according to the prior art. The upper aluminum profiles (2) are tightly closed over the PVC protection (5) by means of the springs (3). In this manner, the formed frame becomes ready for use. Here the number of parts comprising the frame is excessive and the aluminum profiles (2, 6) are produced by means of the extrusion method, hence the manufacturing costs and times are increased.

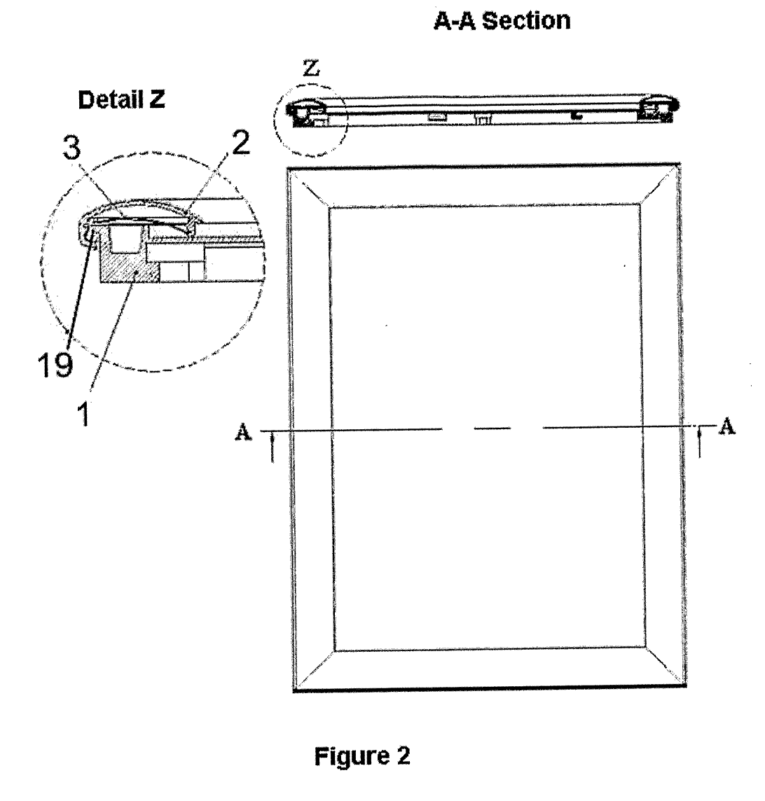

In FIG. 2, the front and cross-sectional views of the body (1) are shown according to a representative embodiment of the invention. As provided in the A-A cross-section and the detail Z, the springs (3) connected to the upper aluminum profiles (2) are mounted on the body (1).

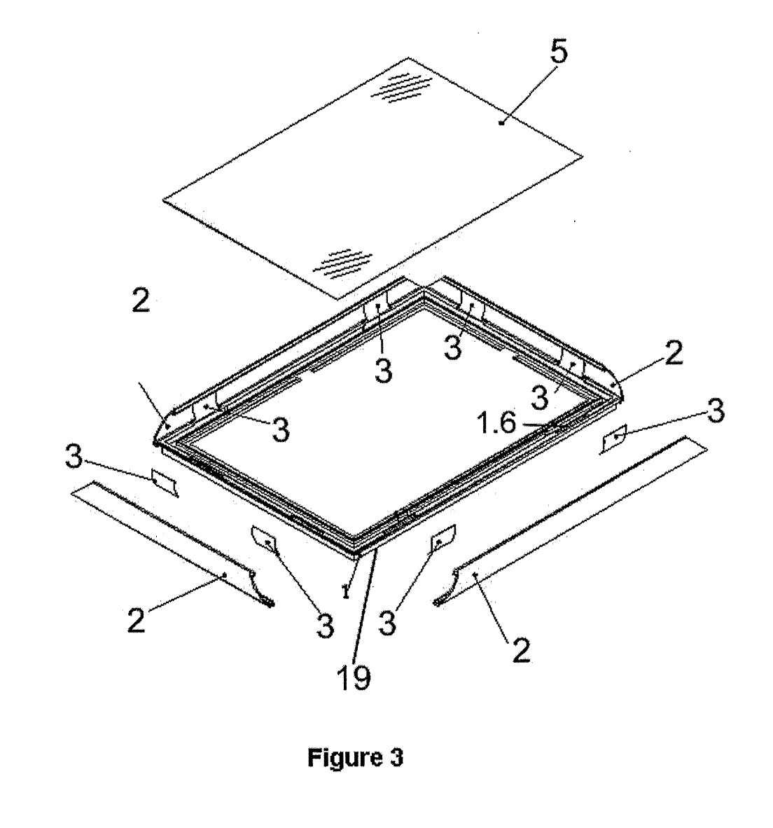

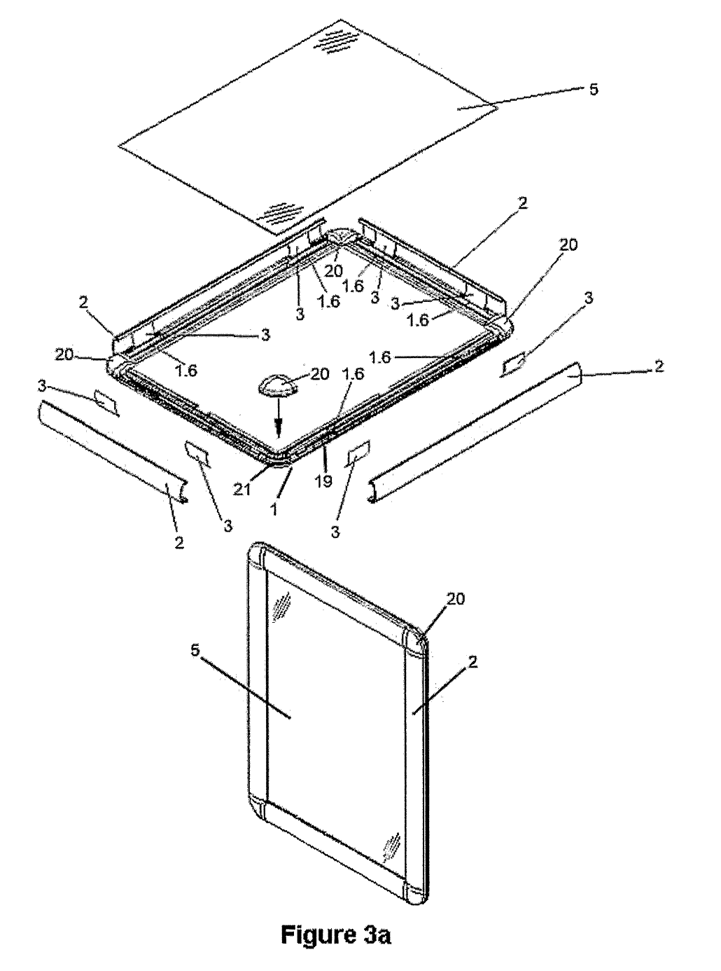

FIG. 3 provides the disassembled view of the frame (1) with the complete body according to a representative embodiment of the invention. The upper aluminum profiles (2) and the springs (3) are mounted to the spring housing (1.6) and the upper aluminum profile housing (19), respectively, formed on the body (1). The PVC protection (5) is mounted within the limits formed on the body (1).

FIG. 3a shows the disassembled and assembled perspective views of the frame with a complete body (1) including the corner connection supports (20) according to an alternative representative embodiment of the invention. The corner connection supports (20) are mounted in the corner connection support housings (21) formed at the corners of the body (1) along with the upper aluminum profiles (2) located on the body (1). In this way, it is made possible to obtain a frame with the corner connection supports (20).

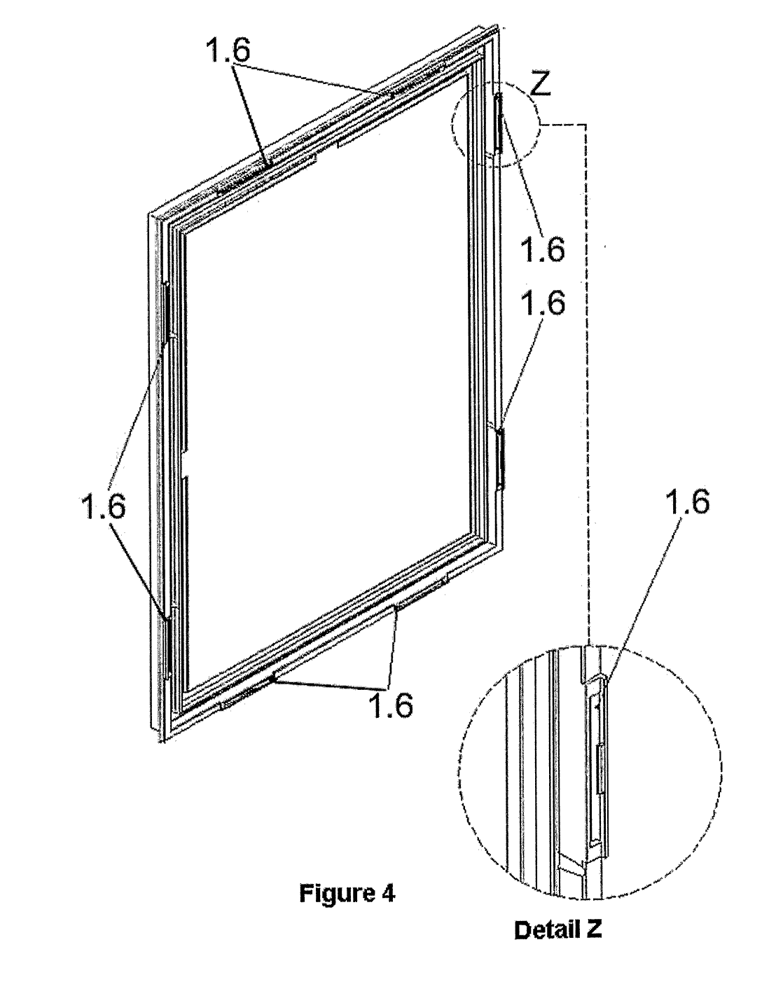

FIG. 4 shows the front view and a detailed perspective view of the body (1) according to a representative embodiment of the invention. Spring housings (1.6) are formed on the body (1). Springs (3) are preferably strip-type springs made of steel.

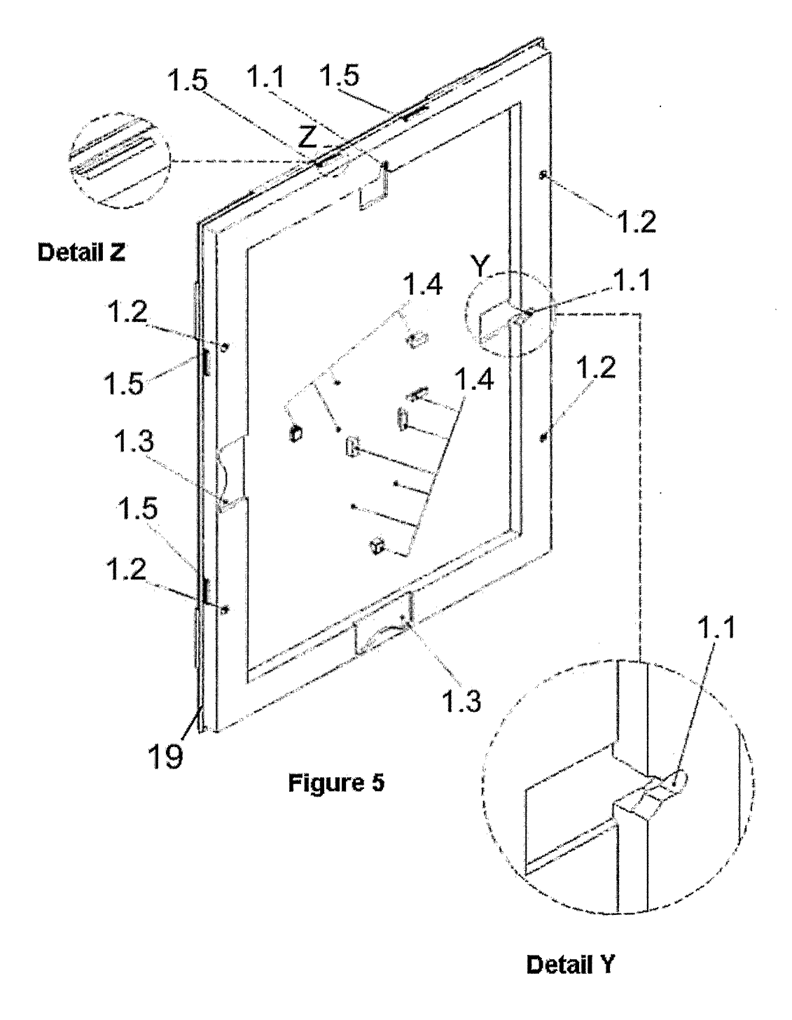

FIG. 5 shows the rear view and a detailed view of the body (1) according to a representative embodiment of the invention. Upper aluminum profile housing (19), upper aluminum profile stopper (1.5), assembly housing (1.2), hanger canal (1.1), thrust unit bearing (1.3) and thrust unit assembly site (1.4) have been formed on the body (1). Thrust unit bearing (1.3) is located on the short and long edges on the body (1). Thrust unit assembly sites (1.4) are formed to enable the thrust unit (4) to be mounted on the body (1). In Detail-Y, the detail of the upper profile stopper (1.5) is provided. Detail-Z provides the detail of the hanger canal (1.1).

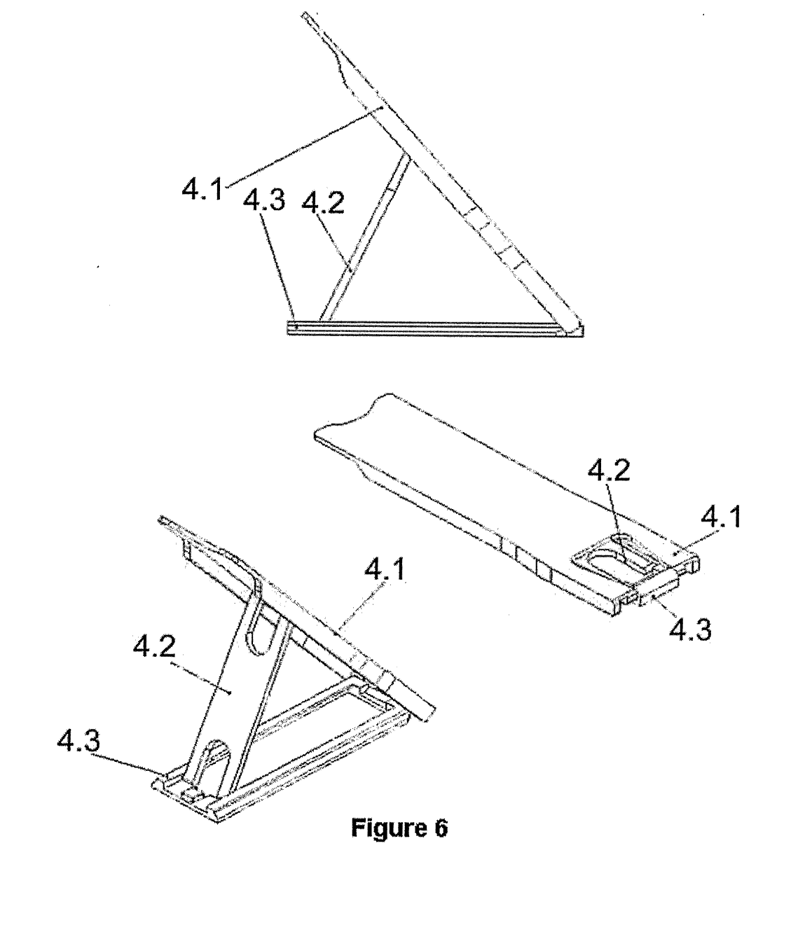

FIG. 6 shows the views of the thrust unit in open and closed states, according to a representative embodiment of the invention. Thrust fixer (4.2) connected with the thrust leg (4.1) operates on the thrust body (4.3). In this way, the use of the thrust unit (4) is made possible in open and closed states and the desired adjustment is possible.

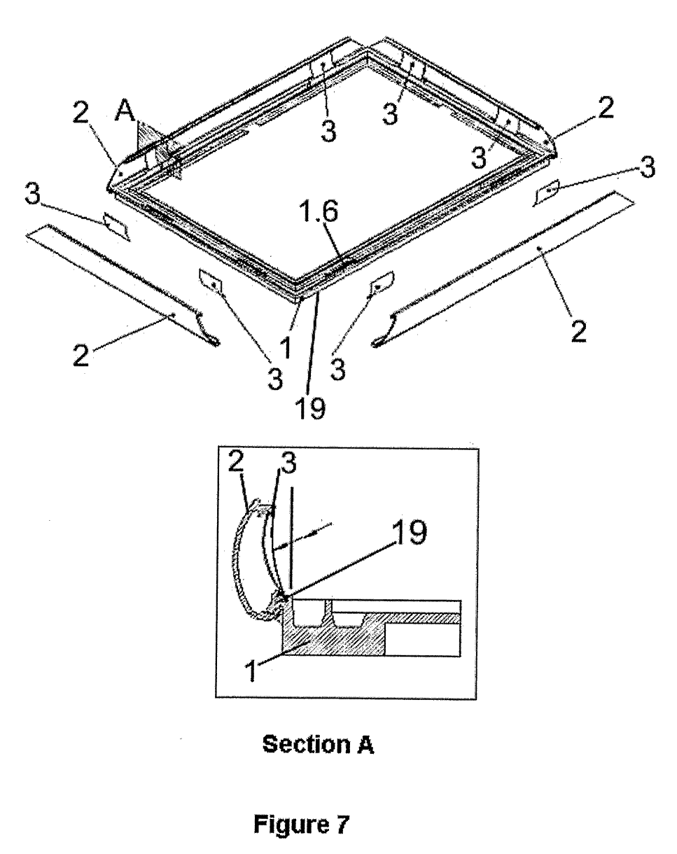

FIG. 7 is a view showing the assembly of the upper aluminum profiles (2) and the springs (3) on the body (1), according to a representative embodiment of the invention. As shown in Section A-A, the upper aluminum profiles (2) connected to the springs (3) are mounted inside the housings (1.6, 19) formed on the body (1) produced as a single piece.

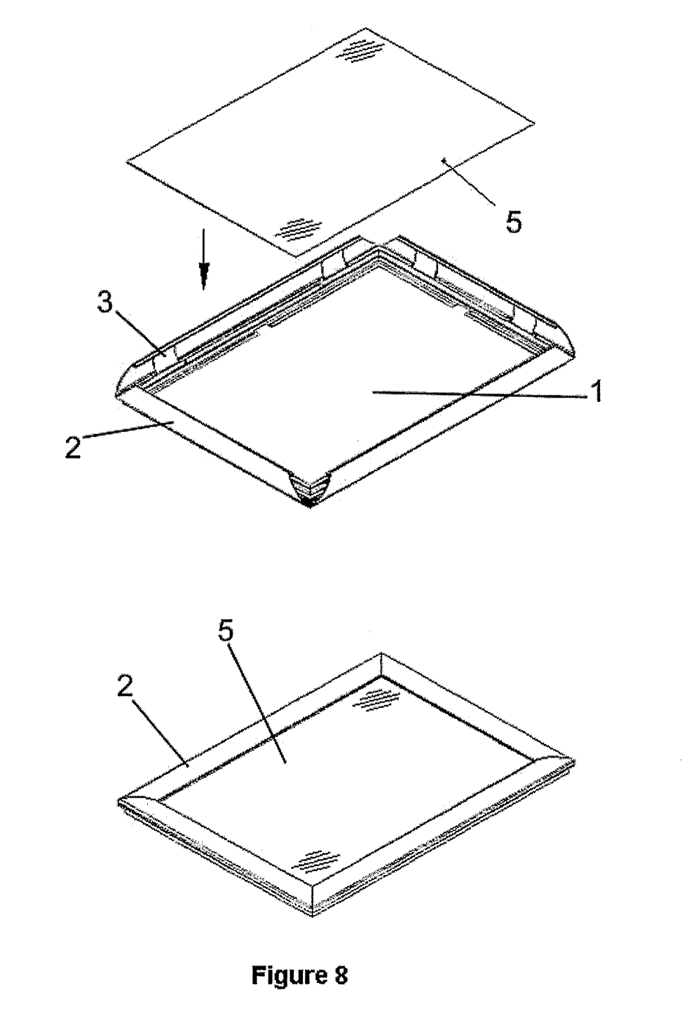

FIG. 8 includes the view showing the assembly of the PVC protection (5) and the perspective view of the frame that is ready for use, according to a representative embodiment of the invention. PVC protection (5) is mounted within the limits formed on the body (1). After the PVC protection (5) has been mounted, the upper aluminum profiles (2) are closed over the PVC protection (5) by means of the springs (3). The frame formed in this way becomes ready for use.

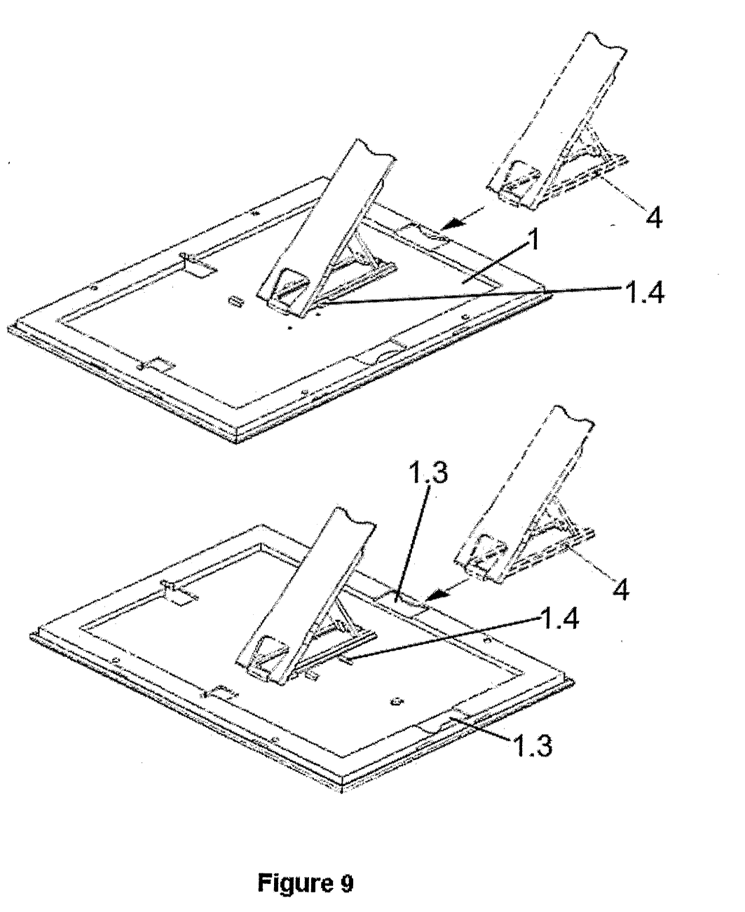

FIG. 9 is a perspective view showing the assembly of the thrust unit (4) on the body (1) in a horizontal and vertical alignment, according to a representative embodiment of the invention. The thrust unit (4) is mounted both in vertical and horizontal alignment by means of the thrust unit assembly sites (1.4) through the thrust unit bearings (1.3) formed on the back side of the body (1). The ease of use is provided with the portable thrust unit (4) mounted in the thrust unit assembly sites (1.4).

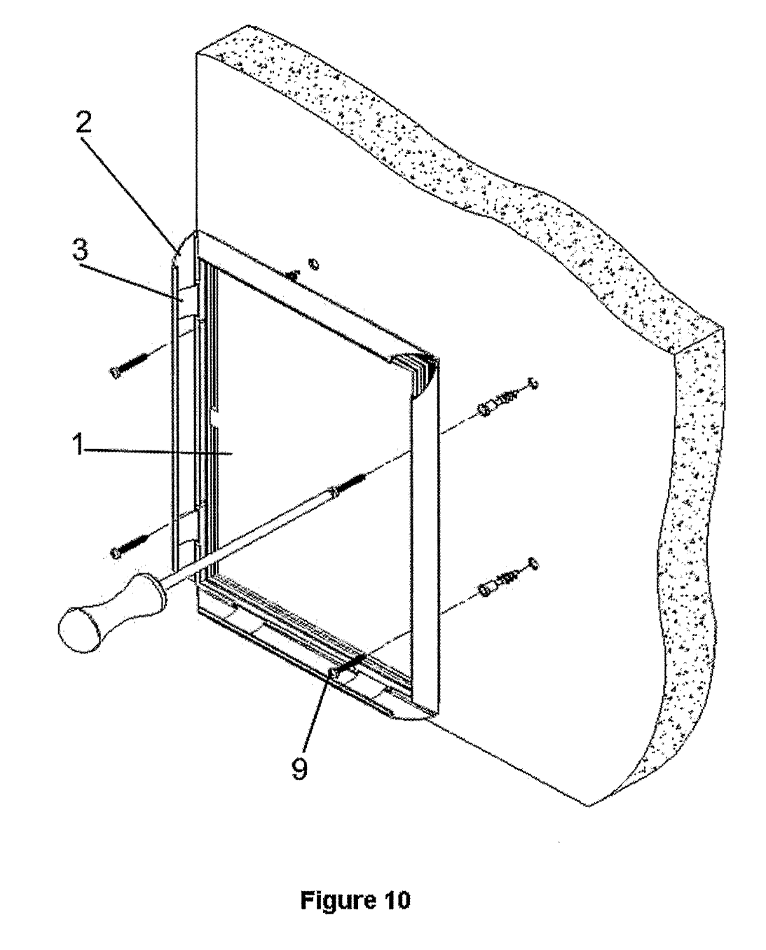

FIG. 10 is a perspective view showing the assembly of the frame onto the wall, according to a representative embodiment of the invention. The frame is mounted by means of the connection means (9) through the assembly sites (1.2) formed on the body (1).

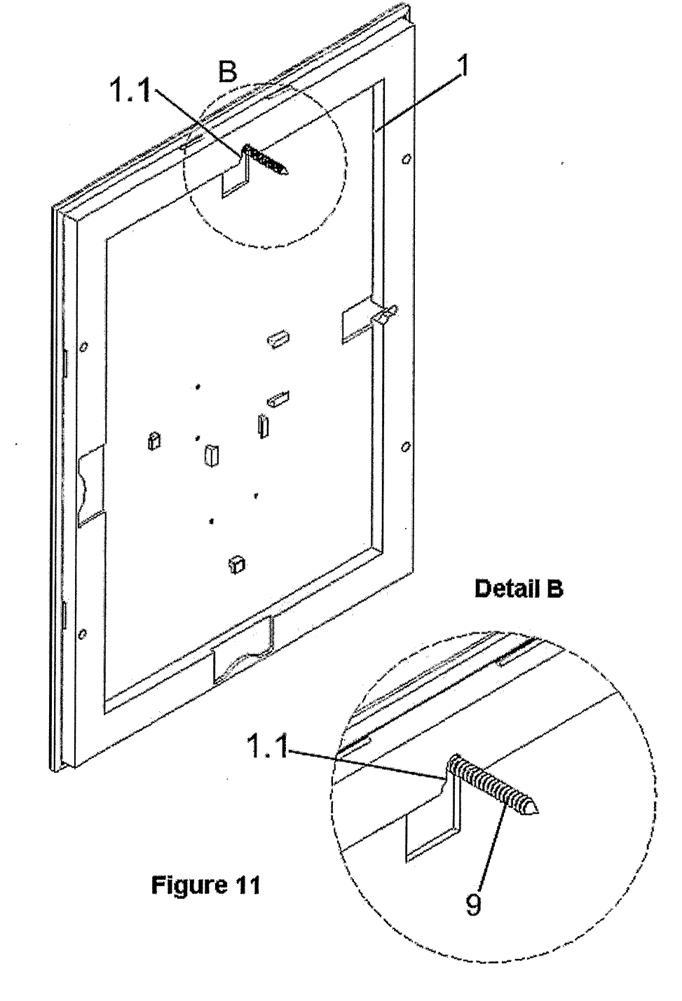

FIG. 11 is a perspective view showing the hanging of the frame by means of the connection with the hanger canals (1.1), according to a representative embodiment of the invention. As show in Detail-B, the frame is mounted by means of the connection means (9) through the hanger canal (1.1) formed on the body (1).

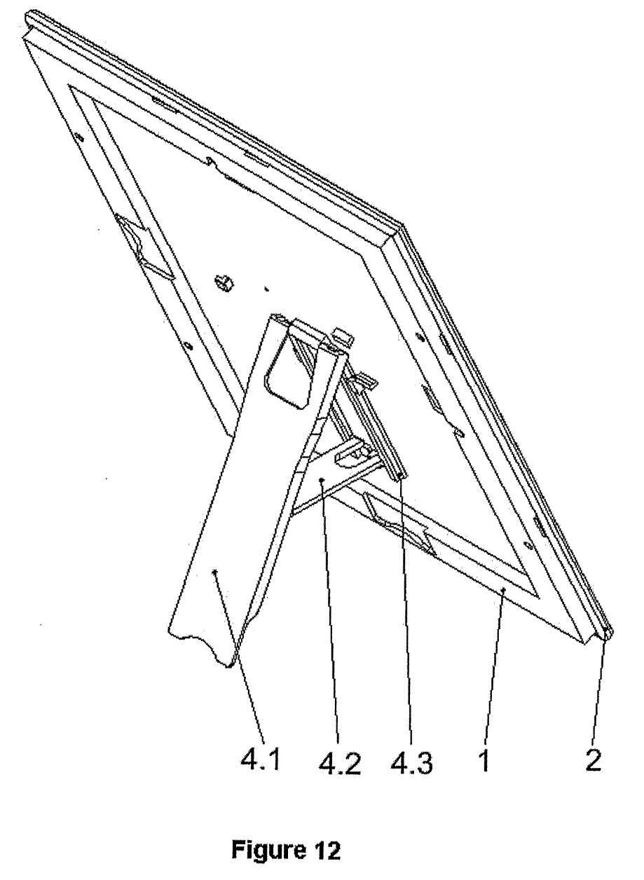

FIG. 12 is a perspective view showing the use of the frame with the thrust unit (4) according to a representative embodiment of the invention. The use of the frame is realized upon the assembly of the thrust unit (4). The position of the thrust unit (4) may be adjusted.

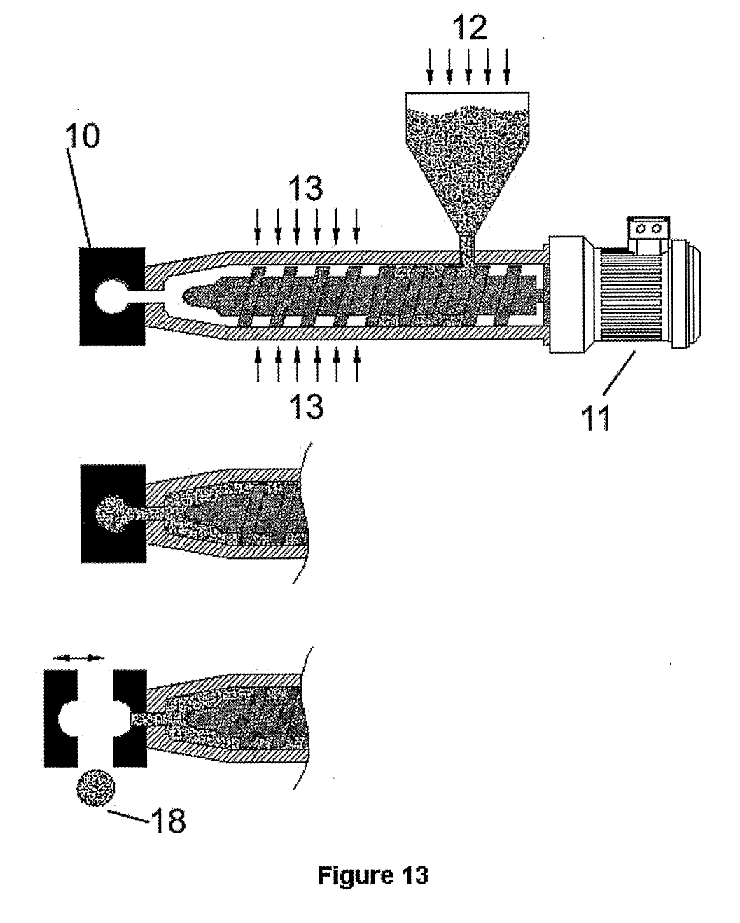

FIG. 13 is a representative view of the production by means of the injection method according to a representative embodiment of the invention. The raw material is supplied through the raw material inlet (12) to the mold (10), by means of the drive element (11), and during the transfer of the raw material to the mold (10); heat (13) is supplied. In this way, the production stages are shortened and savings are provided in the operating costs.

The product (18) is obtained in the shape of the mold (10) in the injection machine. The production is completed at a single stage, without the need for an extra process.

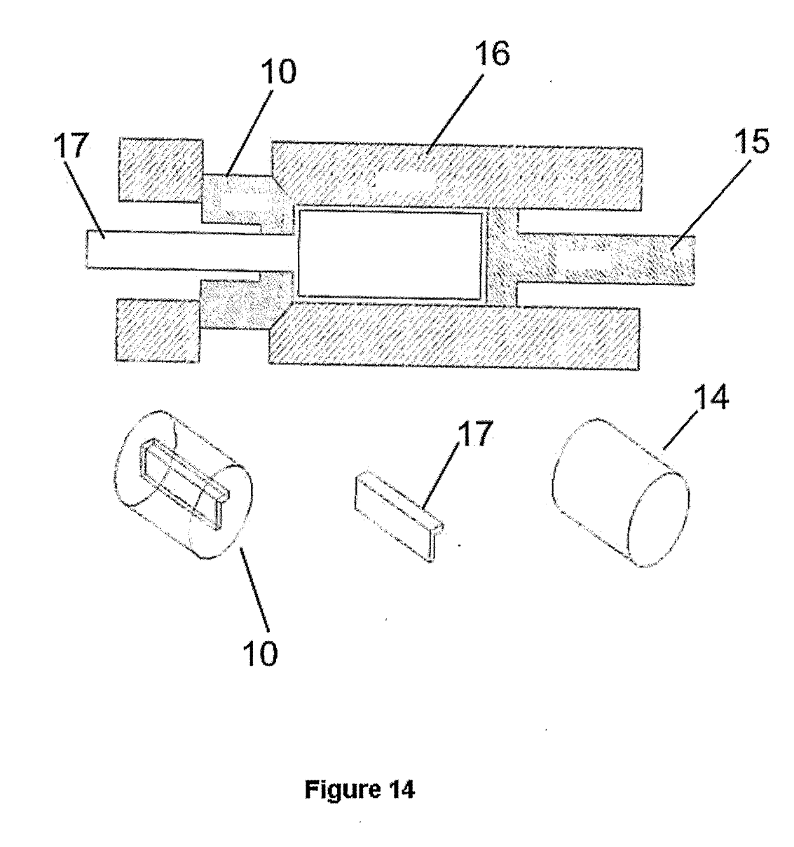

FIG. 14 is a representative view of the production of the aluminum profiles (2, 6) by means of the extrusion method according to the prior art. The mold (10) connected with the case (16) is located. Aluminum rod (14) and the punch (15) are formed inside the case (16). By the pushing force of the punch (15), the aluminum rod (14) in molten form passes through the mold (10) and forms the profile (17). After the profile (17) has been formed, it needs to be subjected to numerous process steps. This means a costly and time consuming production.

This invention is not to be limited to the specific embodiments disclosed herein and modifications for various applications and other embodiments are intended to be included within the scope of the appended claims. While this invention has been described in connection with particular examples thereof, the true scope of the invention should not be so limited since other modifications will become apparent to the skilled practitioner upon a study of the drawings, specification, and following claims.

1-12. (canceled)

13. A frame for displaying an advertisement poster comprising:
a body (1) formed as a single piece;
at least one upper aluminum profile (2); and
at least one spring (3);
wherein
said spring (3) is connected to said upper aluminum profile (2); and
said spring (3) is mounted to said body (1).

14. The frame of claim 13, wherein
said upper aluminum profile (2) is adapted to assume an open position and a closed position;
in said closed position, said upper aluminum profile (2) is biased against said body (1) by said spring (3); and
in said open position, said upper aluminum profile (2) is not biased against said body (1) by said spring (3).

15. The frame of claim 14, wherein said frame does not also comprise a lower aluminum profile (6) connected to said upper aluminum profile (2); a corner connection element (8) for joining said upper aluminum profile (2) to another upper aluminum profile (2); or a background (7) mounted between said upper aluminum profile (2) and said lower aluminum profile (6) to provide support for the advertising poster.

16. The frame of claim 15, wherein said body is formed as a single piece made of plastic by injection molding.

17. The frame of claim 16, wherein said body comprises:
at least one upper aluminum profile housing (19) forming a connection for said upper aluminum profile (2),
at least one spring housing (1.6) forming a connection for said spring (3),
at least one upper profile stopper (1.5) for limiting movement of said upper aluminum profile (2) in said open position, and
at least one opening (1.1) for accommodating connection means (9) for connecting the frame to a wall.

18. The frame of claim 17, wherein said body further comprises at one or more of its corners at least one corner connection support housing (21) for accommodating at least one corner connection support (20).

19. The frame of claim 18, wherein said body further comprises at least one corner connection support (20).

20. The frame of claim 19, wherein said frame further comprises a thrust unit (4) mounted on said body (1).

21. The frame of claim 20, wherein said thrust unit (4) comprises a thrust body (4.3), a thrust fixer (4.2), and a thrust leg (4.1).

22. The frame of claim 21, wherein said thrust unit (4) is mounted to said body (1) by a thrust unit bearing (1.3) disposed on a thrust unit assembly site (1.4).

23. A method for manufacturing the frame of claim 14 comprising:
(a) manufacturing at least one said spring (3);
(b) manufacturing at least one said upper aluminum profile (2) by aluminum extrusion;
(c) manufacturing said body (1) by plastic injection molding; and
(d) mounting said upper aluminum profile (2) and said spring (3) to said body (1).

24. The method of claim 23, further comprising cutting said upper aluminum profile (2) at 45° angle.

25. The method of claim 23, comprising further placing a PVC protective sheet (5) on said body (1).

26. The method of claim 25, wherein moving said aluminum profile (2) into said closed position biases said PVC protective sheet (5) against said body (1).

27. The method of claim 25, whether moving said aluminum profile (2) into said open position allows said PVC protective sheet (5) to be detached from said body (1) and the advertisement poster to be placed or replaced in the frame.
